(19) United States
(12) Patent Application Publication
(10) Pub. No.: US 2012/0099802 A1
(43) Pub. Date: Apr. 26, 2012

(54) IMAGE PROCESSING METHOD AND IMAGE PROCESSING APPARATUS

(76) Inventor: Koji WASHIO, Tokyo (JP)

(21) Appl. No.: 13/275,953

(22) Filed: Oct. 18, 2011

(30) Foreign Application Priority Data
Oct. 21, 2010 (JP) 2010-236118

(51) Int. Cl. G06K 9/36

(52) U.S. Cl. 382/276

(57) ABSTRACT

Disclosed is an image processing method for processing image data having pixels consecutively arranged in two directions orthogonal to each other including setting a first pixel area configured by a first and a second predetermined numbers of pixels, summing up the individual pixel values of the first predetermined number of pixels in a column-wise manner with respect to first pixel columns arranged in one direction summing up the individual pixel values of the second predetermined number of pixels in a column-wise manner with respect to second pixel columns arranged in the other direction, identifying a count of stairs given by differences among the pixel values of the individual pixels in the first pixel area, respectively for one direction and for the other direction, and determining a pixel value of a predetermined pixel contained in the first pixel area.

### BACKGROUND OF THE INVENTION

1. Field of the Invention

The present invention relates to an image processing method and an image processing device, for processing image data having pixels consecutively arranged in two directions orthogonal to each other.

2. Description of Related Art

There has been a problem that a stair-like jaggy is found at the boundary of adjacent different-colored areas, in an image (raster image) formed by a dot, or a gathering of dots. Jaggy makes the image look poor, and is causative of degradation of image quality. Japanese Laid-Open Patent Publication No. 2000-92327 has proposed an image processing method, aiming at suppressing degradation of image quality ascribable to jaggy. The image processing method disclosed in this publication is aimed at reducing height of stairs of the jaggy, by binarizing the individual pixels composing an image to be processed, using a predetermined threshold value, and then by subjecting the binarized image to template matching.

However, the image processing method based on the template matching, as described in Japanese Laid-Open Patent Publication No. 2000-92327, needs the process of matching preliminarily prepared templates with the image to be repeated for the number of times equal to the number of the templates. This brings the amount of computation necessary for the image processing in proportion to the number of templates to be matched, and increases the process load of the image processing.

Also workload for designing the plurality of templates used for the template matching will largely expand. Moreover, workload for incorporating the templates into circuits and program products will grow huge.

Another problem in the image processing method described in Japanese Laid-Open Patent Publication No. 2000-92327, based on the binarization using the predetermined threshold value, is that the jaggy is not successfully resolved in some cases depending on the threshold value. For example, if pixel values ranging from 0 to 100% are binarized using a 50% threshold value, the pixels having pixel values of 0 to 49% are assumed as those having no dots formed therein, so that the jaggy is not resolved at all.

### SUMMARY OF THE INVENTION

The present invention was conceived after considering the above-described problems, the object of which is to effectively suppress degradation of image quality ascribable to jaggy, and, to reduce the process load and workload of the image processing for suppressing degradation of image quality ascribable to jaggy.

In order to achieve at least one of the above object, the image processing method for processing image data having pixels consecutively arranged in two directions orthogonal to each other reflecting one aspect of the present invention includes setting a first pixel area configured by a first predetermined number of pixels arranged in one direction among of the two directions and a second predetermined number of pixels arranged in the other direction, summing up the individual pixel values of the first predetermined number of pixels in a column-wise manner with respect to first pixel columns arranged in one direction in the first pixel area, summing up the individual pixel values of the second predetermined number of pixels in a column-wise manner with respect to second pixel columns arranged in the other direction in the first pixel area, identifying a count of stairs given by differences among the pixel values of the individual pixels in the first pixel area, respectively for one direction and for the other direction, based on the column-wisely summed pixel value obtained by summation made on the first pixel columns and the column-wisely summed pixel value obtained by summation made on the second pixel columns, and determining a pixel value of a predetermined pixel contained in the first pixel area based on the count of stairs in one direction in the first pixel area and the count of stairs in the other direction in the first pixel area.

The above image processing method further includes judging whether the column-wisely summed pixel values obtained by summation made on the second pixel columns monotonously increase or monotonously decrease in one direction or not, and the pixel value of the predetermined pixel is replaced with a quotient obtained by dividing the summed pixel value of the individual pixels contained in the second pixel column including the predetermined pixel with the number of pixels contained in the second pixel column, when the column-wisely summed pixel values obtained by summation made on the second pixel columns monotonously increase or decrease in one direction, the count of stairs in one direction in the first pixel area is 2, and, the count of stairs in the other direction in the first pixel area is 1.

The above image processing method further includes judging whether the column-wisely summed pixel values obtained by summation made on the first pixel columns monotonously increase or monotonously decrease in the other direction or not, and the pixel value of the predetermined pixel is replaced with a quotient obtained by dividing the summed pixel value of the individual pixels contained in the first pixel column including the predetermined pixel with the number of pixels contained in the first pixel column, when the column-wisely summed pixel values obtained by summation made on the first pixel columns monotonously increase or decrease in the other direction, the count of stairs in one direction in the first pixel area is 1, and the count of stairs in the other direction in the first pixel area is 2.

The above image processing method further includes setting a second pixel area configured by a third predetermined number of pixels arranged in one direction out of the two directions, the third predetermined number of pixels being larger than the first predetermined number of pixels, and a fourth predetermined number of pixels arranged in the other direction, the fourth predetermined number of pixels being larger than the second predetermined number of pixels, so as to enclose the first pixel area, summing up the individual pixel values of the third predetermined number of pixels in a column-wise manner with respect to third pixel columns arranged in one direction in the second pixel area, summing up the individual pixel values of the fourth predetermined number of pixels in a column-wise manner with respect to fourth pixel columns arranged in the other direction in the second pixel area, identifying a count of stairs given by differences among the pixel values of the individual pixels in the second pixel area, respectively for one direction and for the other direction, based on the column-wisely summed pixel value obtained by summation made on the third pixel columns and the column-wisely summed pixel value obtained by summation made on the fourth pixel columns and determining a pixel value of a predetermined pixel, based on a combination of a count of stairs in one direction in the first pixel area and a count of stairs in the other direction in the first pixel area and based on a combination of a count of stairs in one direction in the second pixel area and a count of stairs in the other direction in the second pixel area.

In the above image processing method the second pixel area is set, when any one condition selected from (i) the count of stairs in one direction in the first pixel area is 1, and, the count of stairs in the other direction in the first pixel area is 0; (ii) the count of stairs in one direction in the first pixel area is 2, and, the count of stairs in the other direction in the first pixel area is 1; (iii) the count of stairs in one direction in the first pixel area is 0, and, the count of stairs in the other direction in the first pixel area is 1; and (iv) the count of stairs in one direction in the first pixel area is 1, and, the count of stairs in the other direction in the first pixel area is 2, is satisfied.

In the above image processing method the image processing device sets a new second pixel area, assuming the previous second pixel area as a first pixel area, when any one condition selected from (i) the count of stairs in one direction in the second pixel area is 1, and, the count of stairs in the other direction in the second pixel area is 0; (ii) the count of stairs in one direction in the second pixel area is 2, and, the count of stairs in the other direction in the second pixel area is 1; (iii) the count of stairs in one direction in the second pixel area is 0, and, the count of stairs in the other direction in the second pixel area is 1; and (iv) the count of stairs in one direction in the second pixel area is 1, and, the count of stairs in the other direction in the second pixel area is 2, is satisfied.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating major constituents of an image forming apparatus which functions as an image processing device according to one embodiment of the present invention;

FIG. 2A is a drawing illustrating a 3×3 pixel area centered round a target pixel;

FIG. 2B is a drawing illustrating a 5×5 pixel area centered round a target pixel;

FIG. 3 is a drawing illustrating an outline of smoothing;

FIG. 4A is a drawing illustrating relations of conditions for combination of count of stairs in the X-direction, count of stairs in the Y-direction, and monotonous increase or monotonous decrease of column-wise sum of pixel values, with variables representing satisfaction/non-satisfaction of the conditions for combination;

FIG. 4B is a drawing illustrating relations of the variables representing satisfaction/non-satisfaction of the conditions for combination given in FIG. 4A, with output values;

FIG. 5A is a drawing illustrating an exemplary 3×3 pixel area having two stairs in the X-direction and one stair in the Y-direction, and, showing monotonous increase in the X-direction;

FIG. 5B is a drawing illustrating an exemplary 3×3 pixel area having no stair in the Y-direction and one stair in the X-direction, and, showing monotonous increase in the Y-direction;

FIG. 6 is a drawing illustrating correlation of match values and target pixel values;

FIG. 7A is a drawing illustrating exemplary image data before smoothing;

FIG. 7B is a drawing illustrating exemplary image data obtained after smoothing of the image data illustrated in FIG. 7A;

FIG. 8 is a drawing illustrating results of smoothing and various values relevant to the results, obtained while assuming pixels G101 to G106 illustrated in FIG. 7A as the target pixels;

FIG. 9A is a drawing illustrating another exemplary image data before smoothing;

FIG. 9B is a drawing illustrating another exemplary image data obtained after smoothing of the image data illustrated in FIG. 9A;

FIG. 10 is a drawing illustrating results of smoothing and various values relevant to the results, obtained while assuming pixels G201 to G206 illustrated in FIG. 9A as the target pixels;

FIG. 11 is a flow chart illustrating steps S1 to S11 of the smoothing;

FIG. 12 is a flow chart illustrating steps S12 to S23 of the smoothing;

FIG. 13 is a flow chart illustrating steps S24 to S36 of the smoothing; and

FIG. 14 is a flow chart illustrating steps S37 to S45 of the smoothing.

### DESCRIPTION OF THE PREFERRED EMBODIMENTS

Embodiments of the present invention will be detailed below, referring to the attached drawings.

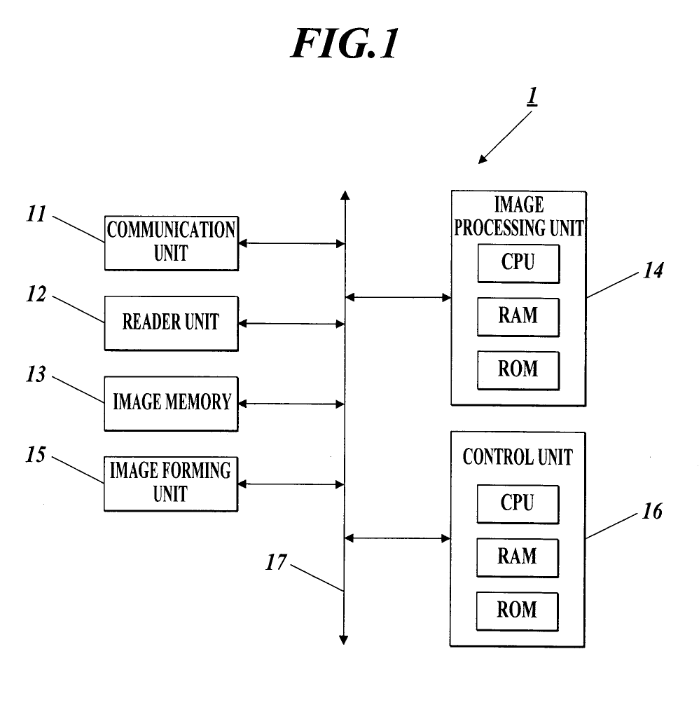

FIG. 1 illustrates major constituents of an image forming apparatus 1 which functions as an image processing device according to one embodiment of the present invention.

The image forming apparatus 1 includes a communication unit 11, a reader unit 12, an image memory 13, an image processing unit 14, an image forming unit 15, a control unit 16 and so forth. The individual units are connected to each other through a bus 17.

The communication unit 11 sends or receives data to or from external instruments. The communication unit 11 typically has a communication device such as network interface card (NIC) through which connection thereof with the external devices (PC, mobile terminal, etc.) are established, and sends or receives data to or from the external devices. For example, original data (image data) for an image to be formed by the image forming apparatus 1 is input from any of the external devices through the communication unit 11 to the image forming apparatus 1.

The reader unit 12 generates the image data by reading documents. The reader unit 12 typically has a light-transmissive copy holder, a light source which irradiates the document placed on the copy holder with light, an image capturing element which converts intensity of light reflected on the document into electric signals, and an image data generation unit which generates image data based on the electric signals received from the image capturing element, and the reader unit 12 is configured to generate image data from the document, by cooperation of these constituents.

The reader unit 12 may have an auto-document feeder (ADF) or the like, in addition to the constituents described in the above, so as to enable automatic reading of paper media set thereon.

The image memory 13 stores the image data. The image data input through the communication unit 11 and the image data generated by the reader unit 12 are stored in the image memory 13.

The image processing unit 14 processes the image data. The image processing unit 14 reads the image data stored in the image memory 13 out therefrom, and subjects it to various types of image processing such as analysis, rasterizing and smoothing, and sends the results to the image forming unit 15. The analysis and rasterizing are not explained herein since they are equivalent to those in the conventional process. The smoothing will be described later.

The image processing unit 14 typically has a CPU, a RAM, a ROM and so forth. The CPU reads a software product from the ROM and executes it, and processes the image data based on the results of execution.

The image forming unit 15 forms an image on a sheet based on the image received from the image processing unit 14. The image forming unit 15 typically has a transfer unit which transfers an image formed by colorant (toner) onto the sheet, a fixing unit which fixes toner transferred onto the sheet, a tray which stocks the sheets, a feed mechanism which draws the sheets out from the tray, and feeds them through the transfer unit and the fixing unit so as to finally deliver the sheet, and other constituents necessary for forming the image.

The control unit 16 controls operations of the individual units of the image forming apparatus 1. The control unit 16 typically has a CPU, a RAM, a ROM and so forth. The CPU reads a software product from the ROM and executes it, and the control unit 16 controls the operations of the individual units of the image forming apparatus 1 based on the results of execution.

Next, out of various types of image processing executed by the image processing unit 14, smoothing will be explained. The smoothing refers to a process for reducing height of stairs causative of jaggy which appears at the boundary of adjacent different-colored areas contained in rasterized image data, depending on a pattern of generation of the jaggy, so as to make it less distinctive.

The rasterized image data is image data having pixels consecutively arranged in two directions orthogonal to each other (for example, the X-direction and the Y-direction).

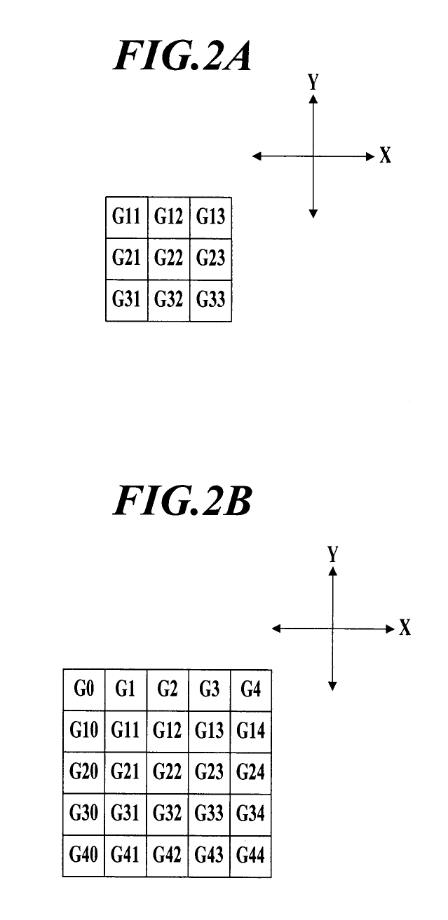

An exemplary pixel area centered round a target pixel G22, will be explained referring to FIGS. 2A, 2B. FIG. 2A illustrates a 3×3 pixel area centered round the target pixel G22, and FIG. 2B illustrates a 5×5 pixel area centered round the target pixel G22.

First, the image processing unit 14 sets the 3×3 and 5×5 pixel areas centered round the target pixel G22. The 5×5 pixel area herein is given as a pixel area one size larger than, and thereby encloses, the 3×3 pixel area.

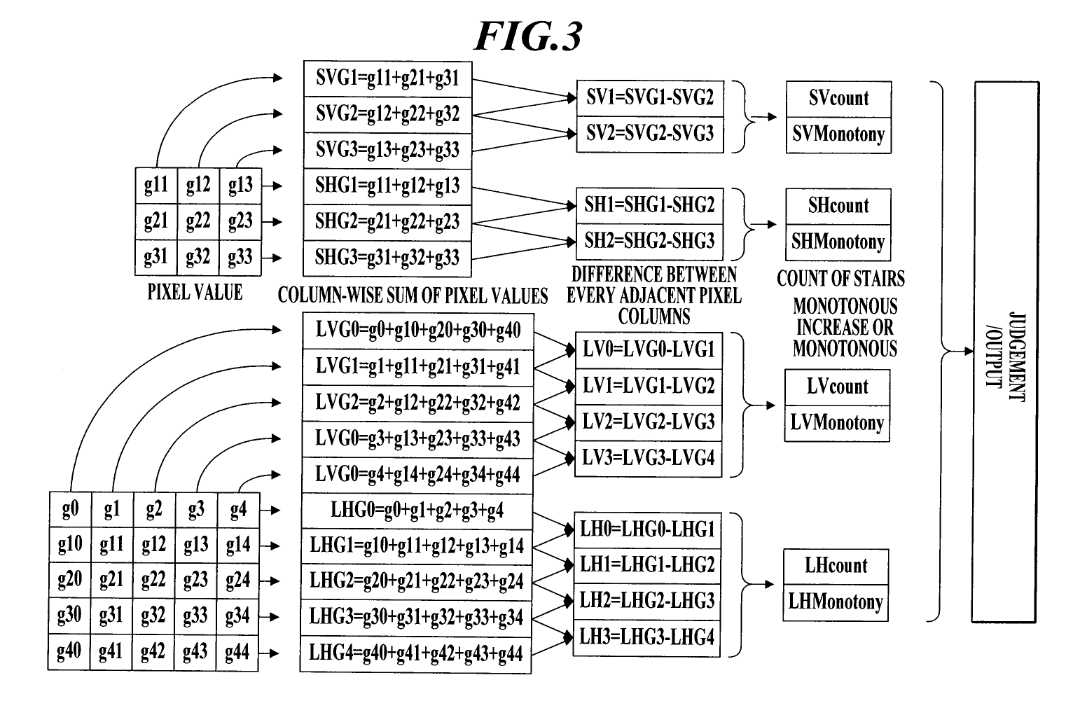

An outline of the smoothing is illustrated in FIG. 3.

Next, the image processing unit 14 sums up the individual pixel values of the pixels contained in the individual pixel columns, in a column-wise manner with respect to the pixel columns arranged in one direction (X-direction, for example) in the individual pixel areas. The image processing unit 14 also sums up the individual pixel values of the pixels contained in the individual pixel columns, in a column-wise manner with respect to the pixel columns arranged in the other direction (Y-direction, for example) in the individual pixel areas.

In the example illustrated in FIGS. 2A and 2B, in the 3×3 pixel area centered round the target pixel G22, the pixel columns aligned in the X-direction include a pixel column containing pixels G11 to G13, a pixel column containing pixels G21 to G23, and a pixel column containing pixels G31 to G33. Further, in the 3×3 pixel area centered round the target pixel G22, the pixel columns aligned in the Y-direction include a pixel column containing the pixels G11, G21 and G31, a pixel column containing the pixels G12, G22 and G32, and a pixel column containing the pixels G13, G23 and G33.

On the other hand, in the 5×5 pixel area centered round the target pixel G22, the pixel columns aligned in the X-direction include a pixel column containing pixels G0 to G4, a pixel column containing pixels G10 to G14, a pixel column containing pixels G20 to G24, a pixel column containing pixels G30 to G34, and a pixel column containing pixels G40 to G44. Further, in the 5×5 pixel area centered round the target pixel G22, the pixel aligned in the Y-direction include a pixel column containing the pixels G0, G10, G20, G30 and G40, a pixel column containing the pixels G1, G11, G21, G31 and G41, a pixel column containing the pixels G2, G12, G22, G32 and G42, a pixel column containing the pixels G3, G13, G23, G33 and G43, and a pixel column containing the pixels G4, G14, G24, G34 and G44.

FIG. 3 and the explanation below define that the pixels G0 to G4 have pixel values g0 to g4, the pixels G10 to G14 have pixel values g10 to g14, the pixels G20 to G24 have pixel values g20 to g24, the pixels G30 to G34 have pixel values g30 to g34, and the pixels G40 to G44 have pixel values g40 to g44.

The image processing unit 14 calculates sums of the individual pixel values of the pixels contained in the individual pixel columns, based on equations (1) to (16) below:

[Mathematical Formula 1]

SHG1=g11+g12+g13 (1)

SHG2=g21+g22+g23 (2)

SHG3=g31+g32+g33 (3)

SVG1=g11+g21+g31 (4)

SVG2=g12+g22+g32 (5)

SVG3=g13+g23+g33 (6)

LHG0=g0+g1+g2+g3+g4 (7)

LHG1=g10+g11+g12+g13+g14 (8)

LHG2=g20+g21+g22+g23+g24 (9)

LHG3=g30+g31+g32+g33+g34 (10)

LHG4=g40+g41+g42+g43+g44 (11)

LVG0=g0+g10+g20+g30+g40 (12)

LVG1=g1+g11+g21+g31+g41 (13)

LVG2=g2+g12+g22+g32+g42 (14)

LVG3=g3+g13+g23+g33+g43 (15)

LVG4=g4+g14+g24+g34+g44 (16)

SHG1 to SHG3 are sums obtained by summing up the pixel values of the individual pixels contained in the pixel columns aligned in the X-direction in the 3×3 pixel area centered round the target pixel G22. SVG1 to SVG3 are sums obtained by summing up the pixel values of the individual pixels contained in the pixel columns aligned in the Y-direction in the 3×3 pixel area centered round the target pixel G22. LHG0 to LHG4 are sums obtained by summing up the individual pixel values of the pixels contained in the pixel columns aligned in the X-direction in the 5×5 pixel area centered round the target pixel G22. LVG0 to LVG4 are sums obtained by summing up the individual pixel values of the pixels contained in the pixel columns aligned in the Y-direction in the 5×5 pixel area centered round the target pixel G22.

Next, the image processing unit 14 identifies a count of stairs given by differences among the pixel values of the individual pixels in the pixel area, respectively for the X-direction and for the Y-direction, based on the column-wisely summed pixel value obtained by summation made on the pixel columns aligned in the X-direction and the column-wisely summed pixel value obtained by summation made on the pixel columns aligned in the Y-direction.

In the process of identifying the count of stairs, first, as illustrated in FIG. 3, the image processing unit 14 obtains differences of column-wise sums of the pixel values of the pixels contained in the individual pixel columns, for every adjacent pixel columns. More specifically, the image processing unit 14 obtains differences of column-wise sums of the pixel values of the pixels contained in the individual pixel columns, for every adjacent pixel columns, based on the equations (17) to (28) below:

[Mathematical Formula 2]

SH1=SHG1−SHG2 (17)

SH2=SHG2−SHG3 (18)

SV1=SVG1−SVG2 (19)

SV2=SVG2−SVG3 (20)

LH0=LHG0−LHG1 (21)

LH1=LHG1−LHG2 (22)

LH2=LHG2−LHG3 (23)

LH3=LHG3−LHG4 (24)

LV0=LVG0−LVG1 (25)

LV1=LVG1−LVG2 (26)

LV2=LVG2−LVG3 (27)

LV3=LVG3−LVG4 (28)

Next, the image processing unit 14 obtains the count of stairs, based on the obtained values of difference. More specifically, the image processing unit 14 judges presence of the stair if the obtained value of difference is not zero, and judges absence of the stair if zero.

In the process of identifying the count of stairs, the image processing unit 14 sets variables for managing the stairs (SVcount, SHcount, LVcount and LHcount, for example), and obtains the count of stairs for each of the X-direction and the Y-direction in the individual pixel areas. In the exemplary case illustrated in FIG. 3, SVcount is set as a variable for managing the count of stairs in the X-direction in the 3×3 pixel area, SHcount is set as a variable for managing the count of stairs in the Y-direction in the 3×3 pixel area, LVcount is set as a variable for managing the count of stairs in the X-direction in the 5×5 pixel area, and LHcount is set as a variable for managing the count of stairs in the Y-direction in the 5×5 pixel area.

Referring now to the 3×3 pixel area, SVcount will be 2 if both of SV1 and SV2 are not zero. SVcount will be 1, if either one of SV1 and SV2 is not zero and the other is 0. SVcount will be 0, if both of SV1 and SV2 are zero. Also for SHcount, LVcount and LHcount, values correspondent to the count of stairs are found and assigned.

Next, the image processing unit 14 judges whether the column-wisely summed pixel values obtained by summation made on the pixel columns aligned in the Y-direction in the individual pixel areas monotonously increase or decrease in the X-direction. More specifically, the image processing unit 14 judges whether the difference of the column-wisely summed pixel values of the pixels contained in the individual pixel columns, for every adjacent pixel columns, monotonously increases or monotonously decreases, in the direction orthogonal to the pixel columns. Note that “monotonous increase” herein means that all of differences of the column-wisely summed pixel values of the pixels contained in the individual pixel columns, for every adjacent pixel columns, are zero or larger. On the other hand, “monotonous decrease” herein means that all of differences of the column-wisely summed pixel values of the pixels contained in the individual pixel columns, for every adjacent pixel columns, are zero or smaller.

The image processing unit 14 now sets variables (SVMonotony and LVMonotony, for example) for managing results of judgment, regarding whether the column-wisely summed pixel values obtained by summation made on the pixel columns aligned in the Y-direction show monotonous increase or decrease in the X-direction. In the exemplary case illustrated in FIG. 3, SVMonotony is a variable for managing whether the column-wisely summed pixel values obtained by summation made on the pixel columns aligned in the Y-direction in the 3×3 pixel area show monotonous increase or decrease in the X-direction. On the other hand, LVMonotony is a variable for managing whether the column-wisely summed pixel values obtained by summation made on the pixel columns aligned in the Y-direction in the 5×5 pixel area show monotonous increase or decrease in the X-direction. Each of SVMonotony and LVMonotony stores either of binary values (1/0, for example) which represent ON/OFF.

For example, if both of SV1 and SV2 are zero or larger or zero or smaller, the 3×3 pixel area is judged to show monotonous increase in the X-direction, with SVMonotony set “ON”. Similarly, if all of LV0 to 4 are zero or larger or zero or smaller, the 5×5 pixel area is judged to show monotonous increase in the X-direction, with LVMonotony set “ON”.

The image processing unit 14 also judges whether the column-wisely summed pixel values obtained by summation made on the pixel columns aligned in the X-direction in the individual pixel areas show monotonous increase or decrease in the Y-direction. Detailed processes are same as those in the judgment regarding whether the column-wisely summed pixel values obtained by summation made on the pixel columns aligned in the Y-direction in the individual pixel areas show monotonous increase or decrease in the X-direction.

The image processing unit 14 sets variables (SHMonotony and LHMonotony, for example) for managing results of judgment regarding whether the column-wisely summed pixel values obtained by summation made on the pixel columns aligned in the X-direction show monotonous increase or decrease in the Y-direction. In the exemplary case illustrated in FIG. 3, SHMonotony is a variable for managing whether the column-wisely summed pixel values obtained by summation made on the pixel columns aligned in the X-direction in the 3×3 pixel area show monotonous increase or decrease in the Y-direction. Further, LHMonotony is a variable for managing whether the column-wisely summed pixel values obtained by summation made on the pixel columns aligned in the X-direction in the 5×5 pixel area show monotonous increase or decrease in the Y-direction. Each of SHMonotony and LHMonotony stores either of binary values (1/0, for example) which represent ON/OFF.

Next, the image processing unit 14 judges whether combinations of the count of stairs in the X-direction and the count of stairs in the Y-direction match with predetermined combinations. The image processing unit 14 also judges whether the column-wise summed pixel values with respect to the pixel columns aligned in one direction in the individual pixel areas monotonously increase or decrease in one direction. The image processing unit 14 then outputs values correspondent to the results of judgment.

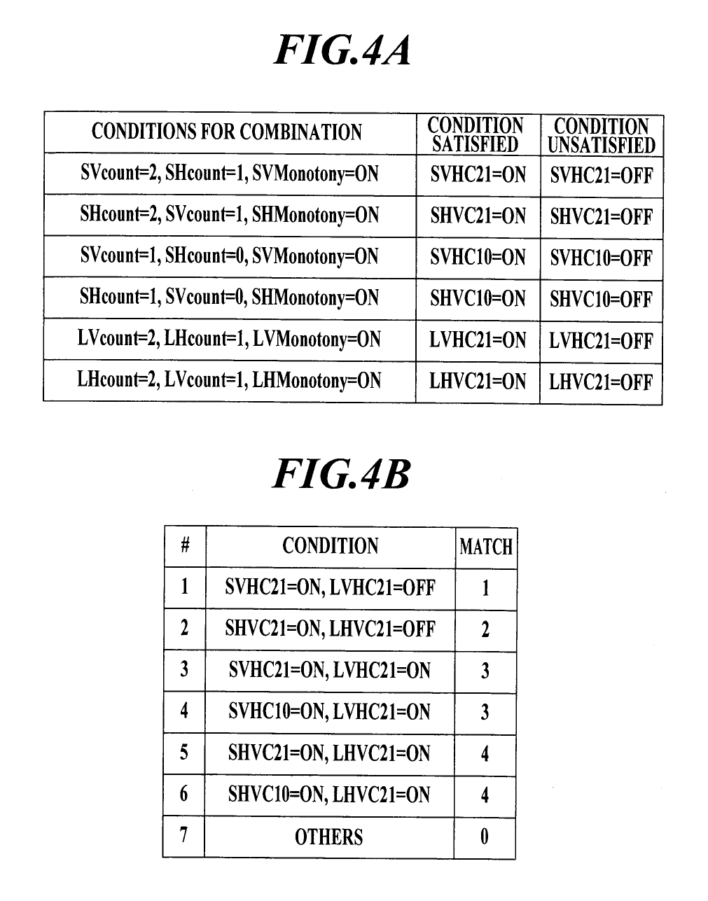

Conditions for combination of the count of stairs in the X-direction and the count of stairs in the Y-direction, conditions for monotonous increase or monotonous decrease of the column-wise sums of the pixel values, and correlation thereof with output values are shown in FIGS. 4A and 4B. FIG. 4A illustrates relations of conditions for combination of count of stairs in the X-direction, count of stairs in the Y-direction, and monotonous increase or monotonous decrease of column-wise sum of pixel values, with variables representing satisfaction/non-satisfaction of the conditions for combination. FIG. 4B illustrates relations of the variables representing satisfaction/non-satisfaction of the conditions for combination given in FIG. 4A, with output values.

The image processing unit 14 sets variables (“SVHC21”, “SHVC21”, “SVHC10”, “SHVC10”, “LVHC21” and “LHVC21”, for example), representing satisfaction/non-satisfaction by ON/OFF (binary values 1/0, for example), with respect to the conditions for combination of the count of stairs in the X-direction, the count of stairs in the Y-direction, and monotonous increase or monotonous decrease of the column-wise sums of the pixel values. The image processing unit 14 judges satisfaction/non-satisfaction of the conditions for combination, based on the variable for managing the stairs, the variable for managing the result of judgment regarding whether the column-wisely summed pixel values obtained by summation made on the pixel columns aligned in the X-direction show monotonous increase or monotonous decrease in the Y-direction, and the variable for managing the result of judgment regarding whether the column-wisely summed pixel values obtained by summation made on the pixel columns aligned in the Y-direction show monotonous increase or monotonous decrease in the X-direction.

As illustrated in FIG. 4A, the image processing unit 14 sets “SVHC21” to ON, when SVcount value is 2, SHcount value is 1, and SHMonotony value is 1. This means that, in the 3×3 pixel area, the count of stairs in the X-direction is 2, the count of stairs in the Y-direction is 1, and, the area shows monotonous increase or monotonous decrease in the X-direction.

The image processing unit 14 sets “SHVC21” to ON, when SHcount value is 2, SVcount value is 1, and SHMonotony value is 1. This means that, in the 3×3 pixel area, the count of stairs in the Y-direction is 2, the count of stairs in the X-direction is 1, and, the area shows monotonous increase or monotonous decrease in the Y-direction.

The image processing unit 14 sets “SVHC10” to ON, when SVcount value is 1, SHcount value is 0, and SVMonotony value is 1. This means that, in the 3×3 pixel area, the count of stairs in the X-direction is 1, the count of stairs in the Y-direction is 0, and, the area shows monotonous increase or monotonous decrease in the X-direction.

The image processing unit 14 sets “SHVC10” to ON, when SHcount value is 1, SVcount value is 0, and SHMonotony value is 1. This means that, in the 3×3 pixel area, the count of stairs in the Y-direction is 1, the count of stairs in the X-direction is 0, and, the area shows monotonous increase or monotonous decrease in the Y-direction.

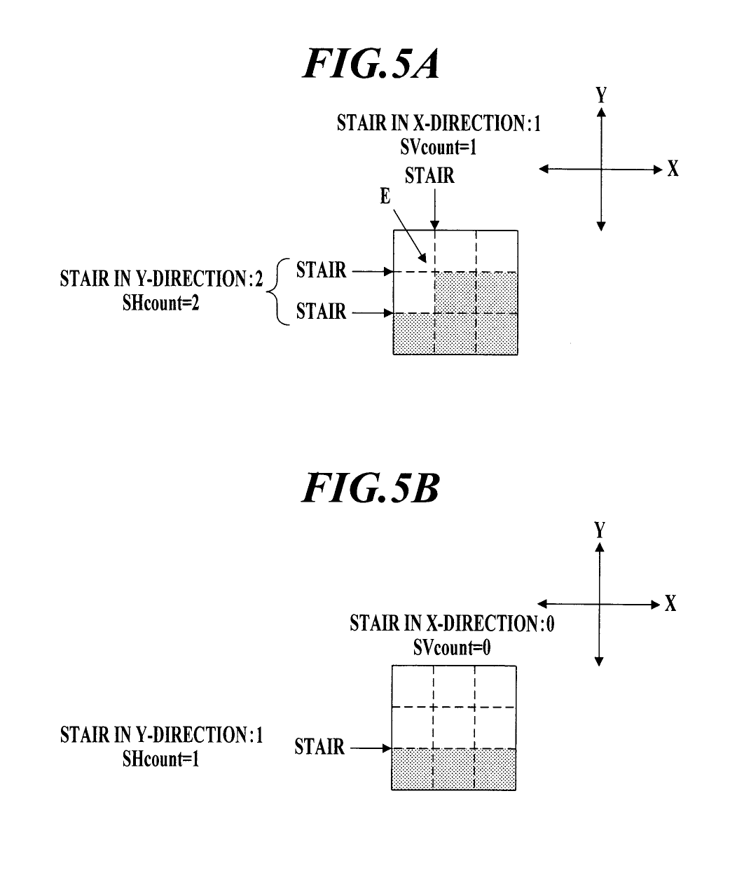

Exemplary dot arrangements, which satisfy conditions for combination, will be explained referring to FIGS. 5A and 5B. FIG. 5A illustrates an exemplary 3×3 pixel area having two stairs in the X-direction and one stair in the Y-direction, and, showing monotonous increase in the X-direction. FIG. 5B illustrates an exemplary 3×3 pixel area having no stair in the Y-direction and one stair in the X-direction, and, showing monotonous increase in the Y-direction. Among the individual pixels illustrated in FIGS. 5A and 5B, the pixels being masked have a uniform pixel value, and the pixels remaining unmasked have a different uniform pixel value.

In the pixel area illustrated in FIG. 5A, there are two boundaries at which different pixel values are bounded in the Y-direction. This means that the count of stairs in the Y-direction is 2. On the other hand, there is a single stair in the X-direction, which means the count of stairs in the X-direction is 1.

In the pixel area illustrated in FIG. 5B, there is a single boundary (stair) at which different pixel values are bounded in the Y-direction. This means that the count of stairs in the Y-direction is 1. On the other hand, there is no stair in the X-direction, which means the count of stairs in the X-direction is 0.

The pixel area having a count of stairs of 2 in one direction and a count of stairs of 1 in the other direction as described in the above will have therein an edge E ascribable to the stairs. On the other hand, the pixel area having a count of stairs of 1 in one direction and a count of stairs of 0 in the other direction will have therein no edge ascribable to the stair.

While FIGS. 5A and 5B exemplify the 3×3 pixel area, the same will apply also to the 5×5 pixel area and to other pixel areas configured by other numbers of pixels. The same will apply also to the case where the X-direction and the Y-direction are exchanged vice versa. Further, while FIGS. 5A and 5B exemplified monotonous increase, the same will apply also to monotonous decrease.

On the other hand, as illustrated in FIG. 4A, the image processing unit 14 sets “LVHC21” to ON, when LVcount value is 2, LHcount value is 1, and LVMonotony value is 1. This means that, in the 5×5 pixel area, the count of stairs in the X-direction is 2, the count of stairs in the Y-direction is 1, and, the area shows monotonous increase or monotonous decrease in the X-direction.

The image processing unit 14 sets “LHVC21” to ON, when LHcount value is 2, LVcount value is 1, and LHMonotony value is 1. This means that, in the 5×5 pixel area, the count of stairs in the Y-direction is 2, the count of stairs in the X-direction is 1, and, the area shows monotonous increase or monotonous decrease in the Y-direction.

Out of all variants which represent satisfaction/non-satisfaction of conditions for combination, those not set to ON are set to OFF.

The image processing unit 14 then outputs values (matches) correspondent to the results of judgment, based on the combinations of the variables which represent satisfaction/non-satisfaction of conditions for combination.

Referring now to FIG. 4B, the image processing unit 14 sets the match to 1, when “SVHC21” is ON and “LVHC21” is OFF. The image processing unit 14 alternatively sets the match to 2, when “SHVC21” is ON and “LHVC21” is OFF. The image processing unit 14 alternatively set the match to 3, when “SVHC21” is ON and “LVHC21” is ON, or when “SVHC10” is ON and “LVHC21” is ON. The image processing unit 14 alternatively sets the match to 4, when “SHVC21” is ON and “LHVC21” is ON, or when “SHVC10” is ON and “LHVC21” is ON. That is, the match may be set to larger values when the conditions for allowing the match to have larger values are satisfied. When none of the conditions is satisfied, the image processing unit 14 sets the match to 0.

Next, the image processing unit determines the pixel value of the target pixel G22, based on the value (match) corresponding to the result of judgment.

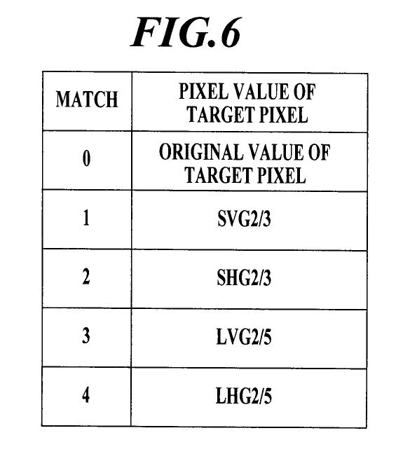

FIG. 6 illustrates correlation of the match values with the pixel values of the target pixel.

More specifically, when the match is 1, the image processing unit 14 replaces the pixel value of the target pixel G22 with a quotient obtained by dividing the value of “SVG2” by 3, and outputs the quotient. The quotient herein is a value obtained by dividing the sum of the pixel values of the individual pixels contained in the pixel column which includes the target pixel G22, before being replaced, out of the pixel columns aligned in the Y-direction in the 3×3 pixel area, by the number of pixels in the pixel column.

When the match is 2, the image processing unit 14 replaces the pixel value of the target pixel G22 with a quotient obtained by dividing the value of “SHG2” by 3, and outputs the quotient. The quotient herein is a value obtained by dividing the sum of the pixel values of the individual pixels contained in the pixel column which includes the target pixel G22, before being replaced, out of the pixel columns aligned in the X-direction in the 3×3 pixel area, by the number of pixels in the pixel column.

When the match is 3, the image processing unit 14 replaces the pixel value of the target pixel G22 with a quotient obtained by dividing the value of “LVG2” by 5, and outputs the quotient. The quotient herein is a value obtained by dividing the sum of the pixel values of the individual pixels contained in the pixel column which includes the target pixel G22, before being replaced, out of the pixel columns aligned in the Y-direction in the 5×5 pixel area, by the number of pixels in the pixel column.

When the match is 4, the image processing unit 14 replaces the pixel value of the target pixel G22 with a quotient obtained by dividing the value of “LHG2” by 5, and outputs the quotient. The quotient herein is a value obtained by dividing the sum of the pixel values of the individual pixels contained in the pixel column which includes the target pixel G22, before being replaced, out of the pixel columns aligned in the X-direction in the 5×5 pixel area, by the number of pixels in the pixel column.

In the cases other than those described in the above, that is, when the match is 0, the image processing unit 14 outputs the pixel value g22 of the target pixel G22 without replacing it.

The smoothing with respect to the target pixel G22 thus completes. The image processing unit 14 carries out the smoothing with respect to the individual pixels contained in the rasterized image data.

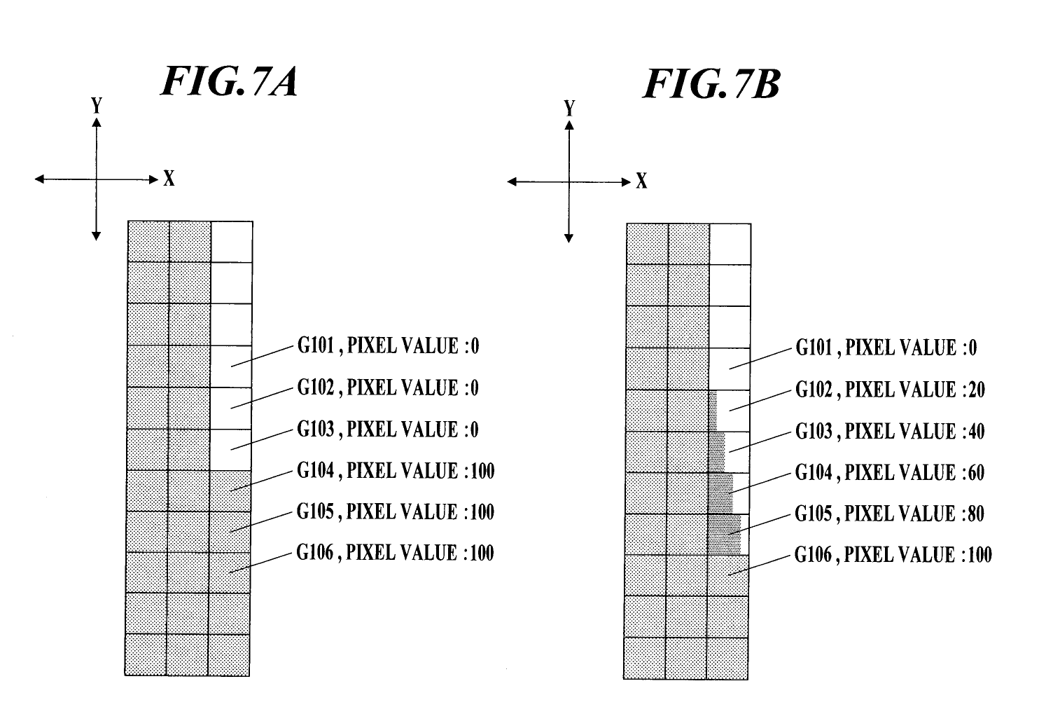

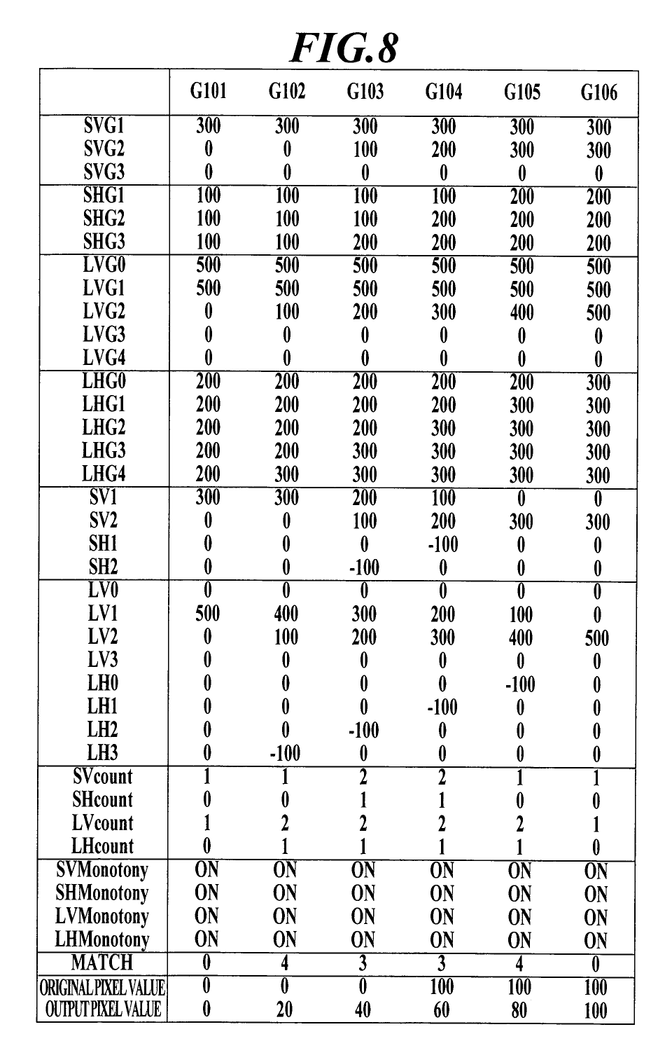

An exemplary result of smoothing will be explained referring to FIGS. 7A, 7B and FIG. 8.

FIGS. 7A and 7B illustrate exemplary image data before and after smoothing. FIG. 7A illustrates exemplary image data before smoothing, and FIG. 7B illustrates exemplary image data obtained after smoothing of the image data illustrated in FIG. 7A.

FIG. 8 illustrates the results of smoothing and various values relevant to the results, obtained while assuming pixels G101 to G106 illustrated in FIG. 7A as the target pixels. FIG. 8 illustrates the values, while assuming the pixel value of the masked pixels in FIG. 7A as 100, and the pixel value of the unmasked pixels as 0.

Assuming now the pixels G101 and G106 illustrated in FIGS. 7A and 7B as the target pixels, as may be understood from FIG. 8, since the count of stairs in the X-direction is 1 and the count of stairs in the Y-direction is 0 for both of the 3×3 pixel area and for the 5×5 pixel area, all of the variables which represent satisfaction/non-satisfaction of conditions for combination will be OFF, except that the “SVHC10” will be ON. None of the conditions for combination given in FIG. 4A is therefore satisfied, and this means that the match will be 0, and thereby the pixel values remain unchanged.

On the other hand, assuming now the pixel G102 illustrated in FIGS. 7A and 7B as the target pixel, as may be understood from FIG. 8, as for the 3×3 pixel area, the count of stairs in the X-direction is 1 and the count of stairs in the Y-direction is 0, whereas as for the 5×5 pixel area, the count of stairs in the X-direction is 2 and the count of stairs in the Y-direction is 1. Accordingly, among the variables which represent satisfaction/non-satisfaction of conditions for combination, “SVHC10” will be ON and “LVHC21” will be ON. The conditions for combination of monotonous increase or monotonous decrease in the X-direction and the Y-direction are satisfied both for the 3×3 and 5×5 pixel areas. This means that the fourth (#4) condition of combination given in FIG. 4A is satisfied, and that the match will be 3. As a consequence, a value (20) obtained by dividing “LGV2” by 5, while assuming the pixel G102 as the target pixel, is output as the pixel value of the pixel G102. Also for the case where the pixels G103 to G105 were assumed as the target pixels, values (40, 60, 80) obtained by dividing “LVG2” by 5 are output, similarly to the case of pixel G102.

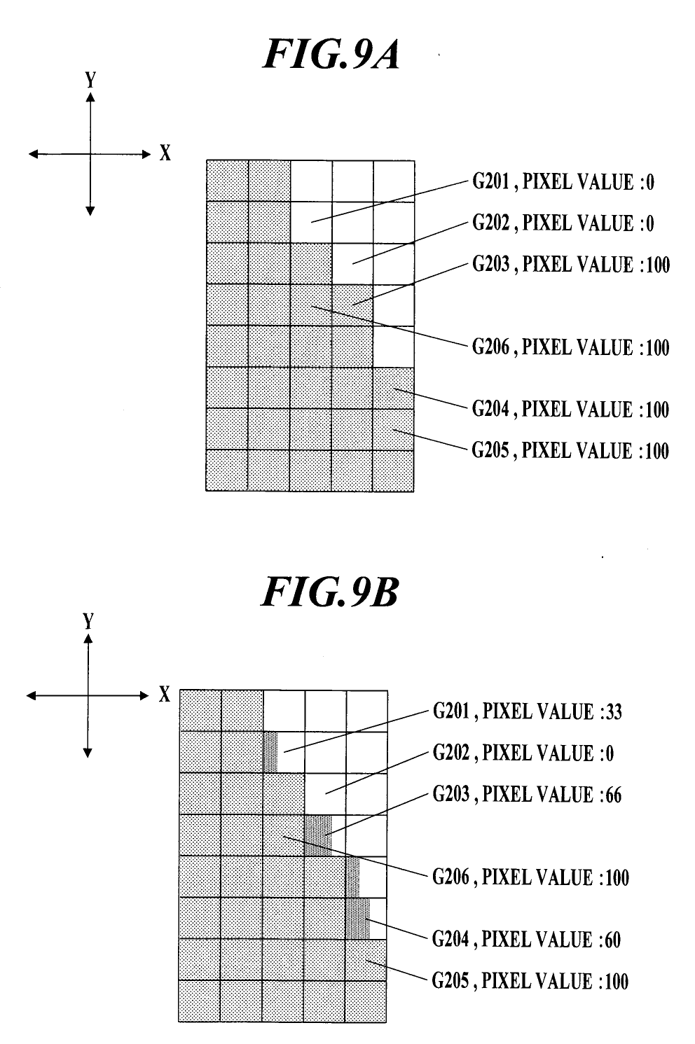

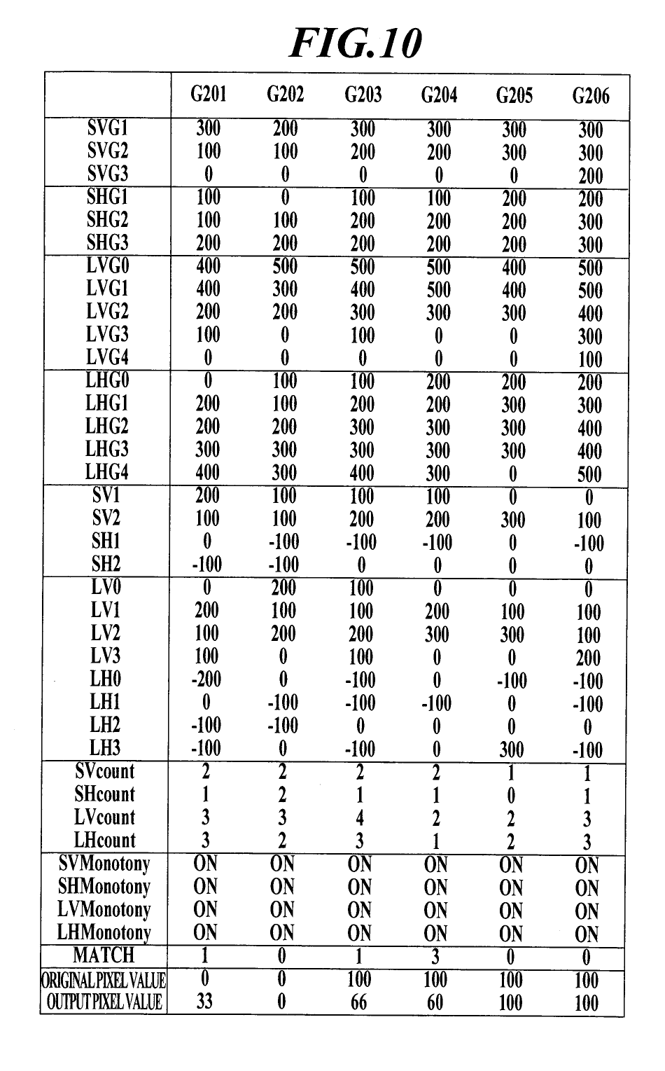

Another exemplary result of smoothing according to this embodiment will be explained referring to FIGS. 9A, 9B and FIG. 10.

FIGS. 9A and 9B illustrate another exemplary image data before and after smoothing. FIG. 9A illustrates another exemplary image data before smoothing, and FIG. 9B illustrates another exemplary image data obtained after smoothing of the image data illustrated in FIG. 9A.

FIG. 10 illustrates the results of smoothing and various values relevant to the results, obtained while assuming pixels G201 to G206 illustrated in FIG. 9A as the target pixels. FIG. 10 illustrates the values, while assuming the pixel value of the masked pixels in FIG. 9A as 100 and the pixel value of the unmasked pixels as 0.

Assuming now the pixel G201 illustrated in FIGS. 9A and 9B as the target pixel, as may be understood from FIG. 10, as for the 3×3 pixel area, the count of stairs in the X-direction is 2 and the count of stairs in the Y-direction is 1, whereas as for the 5×5 pixel area, the count of stairs in the X-direction is 3 and the count of stairs in the Y-direction is 3. Accordingly, among the variables which represent satisfaction/non-satisfaction of conditions for combination, “SVHC21” will be ON and “LVHC21” will be OFF. The conditions for combination of monotonous increase or monotonous decrease in the X-direction and the Y-direction are satisfied both for the 3×3 and 5×5 pixel areas. This means that the first (#1) condition of combination given in FIG. 4A is satisfied, and that the match will be 1. As a consequence, a value (33) obtained by dividing “SVG2” by 3, while assuming the pixel G201 as the target pixel, is output as the pixel value of the pixel G201. Also for the case where the pixel G203 was assumed as the target pixel, a value (66) obtained by dividing “SVG2” by 3 is output, similarly to the case of pixel G201. While the values given in FIG. 10 were obtained by omitting decimals even if they occurred as a result of division of the summed pixel values contained in the pixel columns by the number of pixels, the decimals may alternatively be rounded up.

On the other hand, assuming now the pixel G204 illustrated in FIGS. 9A, 9B as the target pixel, as may be understood from FIG. 10, as for the 3×3 pixel area, the count of stairs in the X-direction is 2 and the count of stairs in the Y-direction is 1, whereas as for the 5×5 pixel area, the count of stairs in the X-direction is 2 and the count of stairs in the Y-direction is 1. Accordingly, among the variables which represent satisfaction/non-satisfaction of conditions for combination, “SVHC21” will be ON and “LVHC21” will be ON. The conditions for combination of monotonous increase or monotonous decrease in the X-direction and the Y-direction are satisfied both for the 3×3 and 5×5 pixel areas. This means that the third (#3) condition of combination given in FIG. 4A is satisfied, and that the match will be 3. As a consequence, a value (60) obtained by dividing “LVG2” by 5, while assuming the pixel G204 as the target pixel, is output as the pixel value of the pixel G204.

Since none of the conditions for combination given in FIG. 4A is satisfied with respect to the pixels G202, G205 and G206, the match will therefore be 0, and thereby the pixel values remain unchanged.

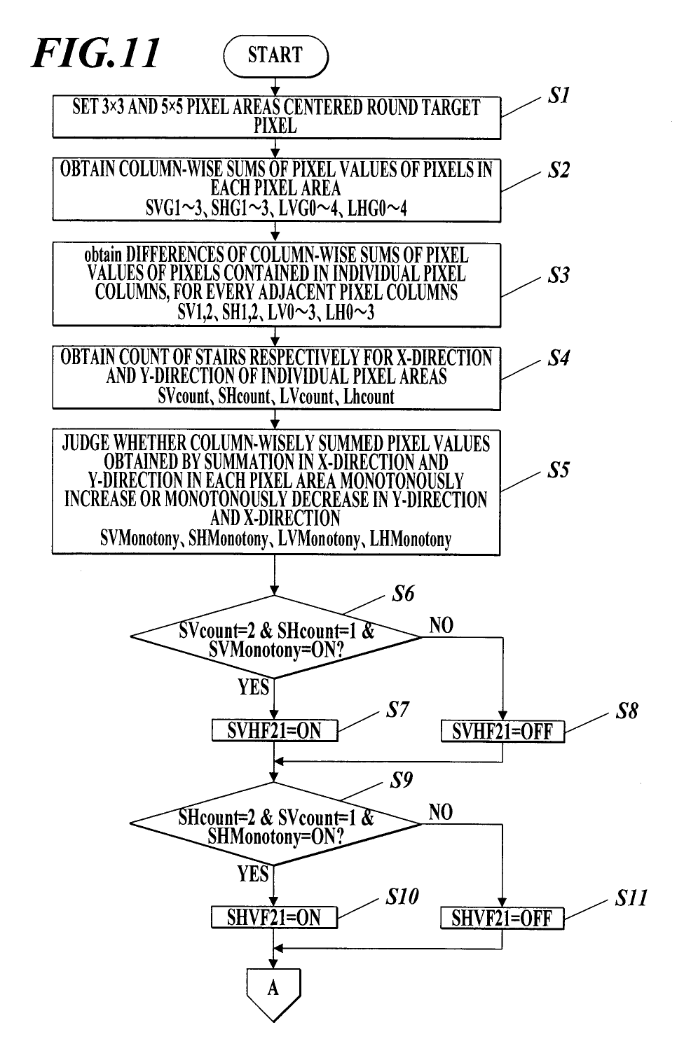

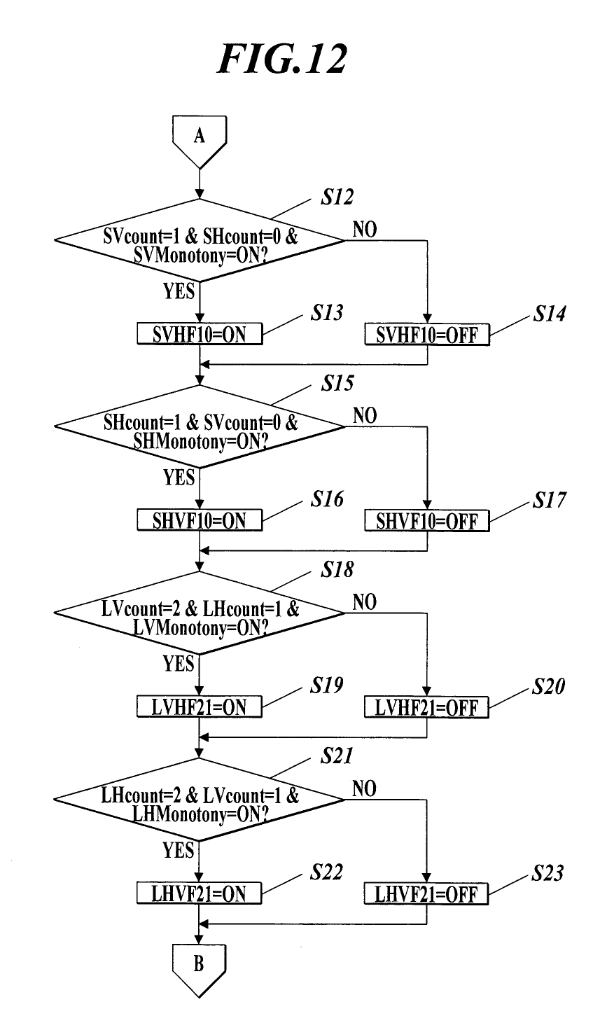

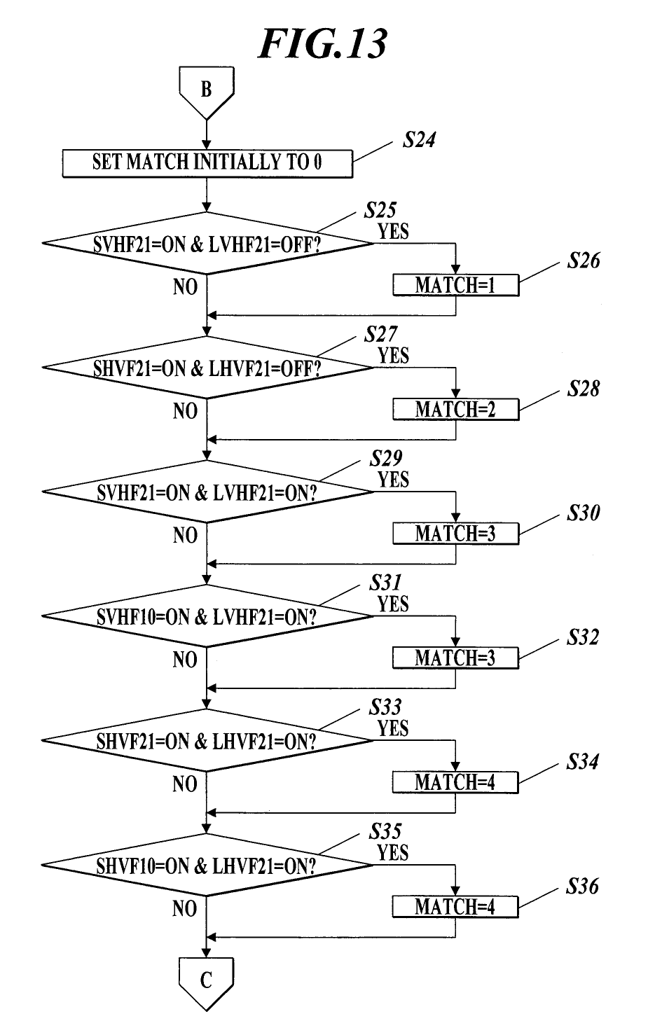

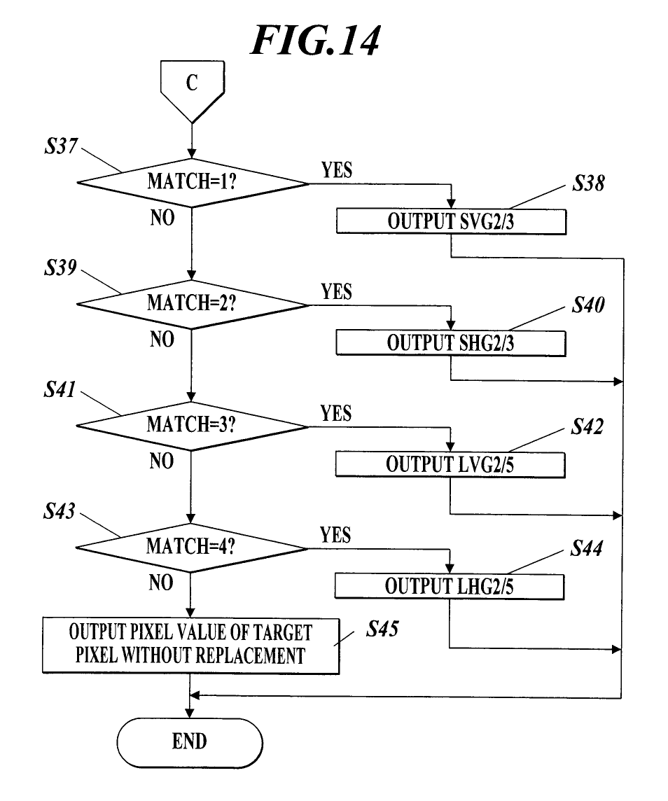

Process flow of the smoothing with respect to the target pixel will be explained below, referring to flow charts illustrated in FIGS. 11 to 14.

The image processing unit 14 sets the 3×3 and 5×5 pixel areas centered round a target pixel (step S1). Next, the image processing unit 14 sums up the pixel values of the individual pixels contained in the individual pixel columns, in a column-wise manner with respect to the pixel columns aligned in the X-direction and the Y-direction in the pixel areas (step S2). Next, the image processing unit 14 obtains differences of column-wise sums of the pixel values of the pixels contained in the individual pixel columns, for every adjacent pixel columns (step S3). Next, the image processing unit 14 obtains the count of stairs respectively for the X-direction and the Y-direction of the individual pixel areas (step S4). The image processing unit 14 also judges whether the column-wisely summed pixel values obtained by summation in the X-direction and the Y-direction in each pixel area monotonously increase or monotonously decrease in the Y-direction and the X-direction (step S5).

Next, the image processing unit 14 judges whether the condition stating SVcount value is 2, SHcount value is 1 and SVMonotony value is 1 is satisfied or not (step S6). When the condition of step S6 is satisfied (step S6: YES), the image processing unit 14 sets “SVHC21” to ON (step S7). When the condition of step S6 is not satisfied (step S6: NO), the image processing unit 14 sets “SVHC21” to OFF (step S8).

The image processing unit 14 also judges whether the condition stating SHcount value is 2, SVcount value is 1 and SHMonotony value is 1 is satisfied (step S9). When the condition of step S9 is satisfied (step S9: YES), the image processing unit 14 sets “SHVC21” to ON (step S10). When the condition of step S9 is not satisfied (step S9: NO), the image processing unit 14 sets “SHVC21” to OFF (step S11).

The image processing unit 14 also judges whether the condition stating SVcount value is 1, SHcount value is 0 and SVMonotony value is 1 is satisfied or not (step S12). When the condition of step S12 is satisfied (step S12: YES), the image processing unit 14 sets “SVHC10” to ON (step S13). When the condition of step S12 is not satisfied (step S12: NO), the image processing unit 14 sets “SVHC10” to OFF (step S14).

The image processing unit 14 also judges whether the condition stating SHcount vslue is 1, SVcount value is 0 and SHMonotony value is 1 is satisfied or not (step S15). When the condition of step S15 is satisfied (step S15: YES), the image processing unit 14 sets “SHVC10” to ON (step S16). When the condition of step S15 is not satisfied (step S15: NO), the image processing unit 14 sets “SHVC10” to OFF (step S17).

The image processing unit 14 also judges whether the condition stating LVcount value is 2, LHcount value is 1 and LVMonotony value is 1 is satisfied or not (step S18). When the condition of step S18 is satisfied (step S18: YES), the image processing unit 14 sets “LVHC21” to ON (step S19). When the condition of step S18 is not satisfied (step S18: NO), the image processing unit 14 sets “LVHC21” to OFF (step S20).

The image processing unit 14 still also judges whether the condition stating LHcount value is 2, LVcount value is 1 and LHMonotony value is 1 is satisfied or not (step S21). When the condition of step S21 is satisfied (step S21: YES), the image processing unit 14 sets “LHVC21” to ON (step S22). When the condition of step S21 is not satisfied (step S21: NO), the image processing unit 14 sets “LHVC21” to OFF (step S23).

The above-described order of processing of steps S6, S9, S12, S15, S18 and S21 is arbitrary, and may be shuffled.

Next, the image processing unit 14 initially sets the match to 0 (step S24). Thereafter, the image processing unit 14 judges whether “SVHC21” is ON and “LVHC21” is OFF (step S25). When the condition of step S25 is satisfied (step S25: YES), the image processing unit 14 sets the match to 1 (step S26).

When the condition of step S25 is not satisfied (step S25: NO) or after the process of step S26, the image processing unit 14 judges whether “SHVC21” is ON and “LHVC21” is OFF (step S27). When the condition of step S27 is satisfied (step S27: YES), the image processing unit 14 sets the match to 2 (step S28).

When the condition of step S27 is not satisfied (step S27: NO) or after the process of step S28, the image processing unit 14 judges whether “SVHC21” is ON and “LVHC21” is ON (step S29). When the condition of step S29 is satisfied (step S29: YES), the image processing unit 14 sets the match to 3 (step S30).

When the condition of step S29 is not satisfied (step S29: NO) or after the process of step S30, the image processing unit 14 judges whether “SVHC10” is ON and “LVHC21” is ON (step S31). When the condition of step S31 is satisfied (step S31: YES), the image processing unit 14 sets the match to 3 (step S32).

When the condition of step S31 is not satisfied (step S31: NO) or after the process of step S32, the image processing unit 14 judges whether “SHVC21” is ON and “LHVC21” is ON (step S33). When the condition of step S33 is satisfied (step S33: YES), the image processing unit 14 sets the match to 4 (step S34).

When the condition of step S33 is not satisfied (step S33: NO) or after the process of step S34, the image processing unit 14 judges whether “SHVC10” is ON and “LHVC21” is ON (step S35). When the condition of step S35 is satisfied (step S35: YES), the image processing unit 14 sets the match to 4 (step S36).

Among the steps of judgment for determining the values of the match, order of execution of those, which result in the same value of match when the conditions for judgment are satisfied, may be arbitrary and may be shuffled. For example, the order of execution of step S29 and step S31 may be exchanged. Similarly, the order of execution of step S33 and step S35 may be exchanged.

When the condition of step S35 is not satisfied (step S35: NO) or after the process of step S36, and when the match is 1 (step S37: YES), the image processing unit 14 outputs a quotient obtained by dividing the value of “SVG2” by 3 as the pixel value of the target pixel (step S38).

When the match is 2 (step S39: YES), the image processing unit 14 outputs a quotient obtained by dividing the value of “SHG2” by 3 as the pixel value of the target pixel (step S40).

When the match is 3 (step S41: YES), the image processing unit 14 outputs a quotient obtained by dividing the value of “LVG2” by 5 as the pixel value of the target pixel (step S42).

When the match is 4 (step S43: YES), the image processing unit 14 outputs a quotient obtained by dividing the value of “LHG2” by 5 as the pixel value of the target pixel (step S44).

When the match is none of 1 to 4 (NO in all of steps S37, S39, S41 and S43) or when the match is 0, the image processing unit 14 outputs the pixel value of the target pixel without replacing it (step S45).

After the process of any of steps S38, S40, S42, S44 and S45, the image processing unit 14 terminates the process of smoothing with respect to the target pixel.

Note that the order of judgment of the values of match is arbitrary, and may be shuffled. Alternatively, a step for judging whether the match is 0 or not may be provided.

According to this embodiment, the image processing unit 14 in the smoothing sets the 3×3 pixel area centered round the target pixel G22. The image processing unit 14 calculates SHG1 to SHG3 as the sums of the pixel values of the individual pixels contained in the pixel columns aligned in the X-direction in the 3×3 pixel area, and calculates SVG1 to SVG3 as the sums of the pixel values of the individual pixels contained in the pixel columns aligned in the Y-direction in the 3×3 pixel area. The image processing unit 14 calculates SH1, SH2, SV1 and SV2 as the differences of column-wise sums of the pixel values of the pixels contained in the individual pixel columns, for every adjacent pixel columns in the 3×3 pixel area. The image processing unit 14 identifies SVcount which represents the count of stairs in the X-direction and SHcount which represents the count of stairs in the Y-direction in the 3×3 pixel area, based on SH1, SH2, SV1 and SV2. The image processing unit 14 determines ON/OFF of “SVHC21”, “SHVC21”, “SVHC10” and “SHVC10”, based on the values of SVcount and SHcount. The image processing unit 14 replaces the pixel value of the target pixel depending on ON/OFF of “LHVC21” and “LVHC21”, when either “SVHC21” or “SHVC21” is set to ON. The image processing unit 14 judges whether the pixel value of the target pixel is to be replaced or not depending on ON/OFF of “LHVC21” and “LVHC21”, when either “SVHC10” or “SHVC10” is set to ON. The image processing unit 14 outputs the pixel value of the target pixel as it is, when all of “SVHC21”, “SHVC21”, “SVHC10” and “SHVC10” are set to OFF.

In this way, the pixels in need of replacement of the pixel values for the purpose of reducing the height of stairs of jaggy and the pixels not in need of replacement may clearly be discriminated, and thereby the smoothing may be completed in a successful manner.

Moreover, according to this embodiment, the smoothing may be completed without template matching. In other words, there is no need of matching between templates and image data. Accordingly, expansion of the amount of computation necessary for the image processing in proportion to the number of templates to be matched, and increase in the process load of the image processing, both of which having been drawbacks of the prior art, may be resolved. In addition, since this embodiment needs no templates, it is no longer necessary to design the templates nor incorporate the templates into the circuits and program products. Accordingly, expansion of workload for designing the plurality of templates used for the template matching, and expansion of workload for incorporating the templates into circuits and program products, both of which having been drawbacks of the prior art, may be resolved. As may be understood from the above, the process load and workload necessary for the smoothing may considerably be decreased.

Moreover, this embodiment includes no process for binarization which has been included in the prior art. This advantageously resolves the conventional problem that the jaggy could not be removed due to the binarization, and thereby makes the smoothing more successful.

The image processing unit 14 judges whether the column-wisely summed pixel values obtained by summation in the Y-direction in each pixel area monotonously increase or monotonously decrease in the X-direction. The result of judgment determines ON/OFF of the variant (SVMonotony). The image processing unit 14 sets “SVHC21” to ON when SVcount is 2, SHcount is 1 and SVMonotony is ON. The image processing unit 14 sets the match to 1, replaces the pixel value of the target pixel G22 with a quotient obtained by dividing “SVG2” by 3, and outputs the replaced value, when “SVHC21” is ON and “LVHC21” is OFF.

Since the pixel value is replaced when the column-wisely summed pixel values obtained by summation made on the pixel columns aligned in the Y-direction monotonously increase or monotonously decrease in the X-direction as described in the above, it is no longer anticipated that the edge of a single protruded or concaved pixel in the midst of three consecutive of pixels is unnecessarily smoothened, and thereby such geometry which should not be reduced in height of stairs is successfully prevented from being unnecessarily smoothened.

Also, since the pixel value of the target pixel G22 is replaced by the value obtained by dividing “SVG2” by 3, or more specifically, by the value obtained by dividing the summed pixel values of the individual pixels contained in the pixel column which includes the target pixel G22 before being replaced, out of all pixel columns aligned in the Y-direction in the 3×3 pixel area, by the number of pixels in the pixel column and is then output, an average of the pixel values contained in the pixel column is reflected on the pixel value of the target pixel. This embodiment configured as described in the above may be adoptable to all cases having a variety of pixel values of the rasterized image data, needs no binarization unlike the prior art, and can avoid the problem that the jaggy could not occasionally be removed due to binarization.

The image processing unit 14 judges whether the column-wisely summed pixel values obtained by summation in the X-direction monotonously increase or monotonously decrease in the Y-direction. The result of judgment determines ON/OFF of the variant (SHMonotony). The image processing unit 14 sets “SHVC21” to ON, when SVcount is 1, SHcount is 2 and SHMonotony is ON. The image processing unit 14 sets the match to 1, replaces the pixel value of the target pixel G22 with a quotient obtained by dividing the value of “SHG2” by 3, and outputs the replaced value, when “SHVC21” is ON and “LHVC21” is OFF.

Since the pixel value is replaced only when the column-wisely summed pixel values obtained by summation made on the pixel columns aligned in the X-direction monotonously increase or monotonously decrease in the Y-direction as described in the above, it is no longer anticipated that the edge of a single protruded or concaved pixel in the midst of three consecutive of pixels is unnecessarily smoothened, and thereby such geometry which should not be reduced in height of stairs is successfully prevented from being unnecessarily smoothened.

Also, since the pixel value of the target pixel G22 is replaced by the value obtained by dividing “SVG2” by 3, or more specifically, by the value obtained by dividing the summed pixel values of the individual pixels contained in the pixel column which includes the target pixel G22 before being replaced, out of all pixel columns aligned in the X-direction in the 3×3 pixel area, by the number of pixels in the pixel column and is then output, an average of the pixel values contained in the pixel column is reflected on the pixel value of the target pixel. This embodiment configured as described in the above may be adoptable to all cases having a variety of pixel values of the rasterized image data, needs no binarization unlike the prior art, and can avoid the problem that the jaggy could not occasionally be removed due to binarization.

The image processing unit 14 also sets the 5×5 pixel area centered round the target pixel G22. The image processing unit 14 calculates LHG0 to LHG4 as the sums of the pixel values of the individual pixels contained in the pixel columns aligned in the X-direction in the 5×5 pixel area, and calculates LVG0 to LVG4 as the sums of the pixel values of the individual pixels contained in the pixel columns aligned in the Y-direction in the 5×5 pixel area. The image processing unit 14 calculates LH0 to LH3 and LV0 to LV3 as the differences of column-wise sums of the pixel values of the pixels contained in the individual pixel columns, for every adjacent pixel columns in the 5×5 pixel area. The image processing unit 14 identifies LVcount which represents the count of stairs in the X-direction and LHcount which represents the count of stairs in the Y-direction in the 5×5 pixel area, based on LH0 to LH3 and LV0 to LV3. The image processing unit 14 determines ON/OFF of “LVHC21” and “LHVC21”, based on the values of LVcount and LHcount. The image processing unit 14 replaces the pixel value of the target pixel depending on ON/OFF of “LHVC21” and “LVHC21”, when either “SVHC21” or “SHVC21” is set to ON. The image processing unit 14 judges whether the pixel value of the target pixel is replaced or not depending on ON/OFF of “LHVC21” and “LVHC21”, when either “SVHC10” or “SHVC10” is set to ON.

Since the count of stairs may be judged based on the 5×5 pixel area wider than the 3×3 pixel area, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

It is to be understood that the embodiment of the present invention disclosed in the above is merely representative and not restrictive in all aspects. The scope of the present invention is depicted not by the explanation in the above but by the appended claims, and is intended to include all modifications which are semantically equivalent to the claims and fall in the scope thereof.

In the above-described embodiment, the 3×3 pixel area was exemplified by the first pixel area while assuming the first predetermined number of pixels arranged in the X-direction as 3 and the second predetermined number of pixels arranged in the Y-direction as 3, in which the first pixel column was defined to contain three pixels aligned in the X-direction and the second pixel column was defined to contain three pixels aligned in the Y-direction. In the above-described embodiment, the 5×5 pixel area was exemplified by the second pixel area while assuming the third predetermined number of pixels arranged in the X-direction as 5 and the fourth predetermined number of pixels arranged in the Y-direction as 5, in which the third pixel column was defined to contain five pixels aligned in the X-direction and the fourth pixel column was defined to contain five pixels aligned in the Y-direction. The number of pixel areas set herein is not limited to two. For example, three pixel areas having sizes of 3×3, 5×5 and 7×7 may be set, or four or more pixel areas including 7×7 or larger pixel areas may be set. Note that any larger pixel area is set so as to enclose any smaller pixel area.

Alternatively, the process may be carried out using only a single pixel area (only the 3×3 pixel area, for example). In this case, the match is set to 1 when “SVHC21” is ON and SHMonotony is ON, the match is set to 2 when “SHVC21” is ON and SHMonotony is ON, and the match is set to 0 for the other cases. The other processes are same as those in the embodiment described in the above.

Alternatively, a pixel area one size larger than a certain pixel area may be set, when the counts of stairs (x:y), defined herein to represent the count of stairs “x” in the X-direction and the count of stairs “y” in the Y-direction in the certain pixel area, is given by any one of (1:0), (2:1), (0:1) and (1:2). In addition, the pixel values of the target pixel area may be replaced, based on the column-wise sum of the pixel values of the individual pixels contained in the pixel columns aligned in the X-direction and the Y-direction in the one-size-larger pixel area and based on the count of stairs in the one-size-larger pixel area. The one-size-larger pixel area herein means a pixel area larger by two pixels both in the X-direction and in the Y-direction, such as a 7×7 pixel area over the 5×5 pixel area, and a 9×9 pixel area over the 7×7 pixel area. In addition, when (x:y) of the original pixel area is given by (1:0) or (2:1), and (x:y) of the one-size-larger pixel area is given by (2:1), a value obtained by dividing the sum of the pixel values of the pixels contained in the pixel column, which is aligned in the Y-direction of the one-size-larger pixel area and includes the target pixel, by the number of pixels of the pixel column, is determined as the pixel value of the target pixel. On the other hand, when (x:y) of the original pixel area is given by (0:1) or (1:2), and (x:y) of the one-size-larger pixel area is given by (1:2), a value obtained by dividing the sum of the pixel values of the pixels contained in the pixel column, which is aligned in the X-direction of the one-size-larger pixel area and includes the target pixel, by the number of pixels of the pixel column, is determined as the pixel value of the target pixel.

While the image processing unit 14 carries out the smoothing in the above-described embodiment, the control unit 16 may alternatively carry out the smoothing. Any processing unit dedicated for the smoothing may be provided, or the smoothing may be carried out by hardware-based processes using any dedicated circuit and so forth, rather than by software-based processes.

While the smoothing in the above-described embodiment was carried out by the image processing unit 14 provided to the image forming apparatus 1, the smoothing may alternatively be carried out by a separate image processing apparatus externally provided to the image forming apparatus in an independent manner.

According to one aspect of the preferred embodiment of the present invention, an image processing method for processing image data having pixels consecutively arranged in two directions orthogonal to each other includes setting a first pixel area configured by a first predetermined number of pixels arranged in one direction out of the two directions and a second predetermined number of pixels arranged in the other direction, summing up the individual pixel values of the first predetermined number of pixels in a column-wise manner with respect to first pixel columns arranged in one direction in the first pixel area, summing up the individual pixel values of the second predetermined number of pixels in a column-wise manner with respect to second pixel columns arranged in the other direction in the first pixel area, identifying a count of stairs given by differences among the pixel values of the individual pixels in the first pixel area, respectively for one direction and for the other direction, based on the column-wisely summed pixel value obtained by summation made on the first pixel columns and the column-wisely summed pixel value obtained by summation made on the second pixel columns, and determining a pixel value of a predetermined pixel contained in the first pixel area based on the count of stairs in one direction in the first pixel area and the count of stairs in the other direction in the first pixel area.

According to this embodiment, the pixels in need of replacement of the pixel values for the purpose of reducing the height of stairs of jaggy and the pixels not in need of replacement may clearly be discriminated, and thereby the smoothing may be completed in a successful manner. Moreover, according to this embodiment, the smoothing may be completed without template matching. In other words, there is no need of matching between templates and image data. Accordingly, expansion of the amount of computation necessary for the image processing in proportion to the number of templates to be matched, and increase in the process load of the image processing, both of which having been drawbacks of the prior art, may be resolved. In addition, since this embodiment needs no templates, it is no longer necessary to design the templates nor incorporate the templates into the circuits and program products. Accordingly, expansion of workload for designing the plurality of templates used for the template matching, and expansion of workload for incorporating the templates into circuits and program products, both of which having been drawbacks of the prior art, may be resolved. As may be understood from the above, the process load and workload necessary for the smoothing may considerably be decreased. Moreover, this embodiment includes no process for binarization which has been included in the prior art. This advantageously resolves the conventional problem that the jaggy could not be removed due to the binarization, and thereby makes the smoothing more successful.

The image processing method further includes judging whether the column-wisely summed pixel values obtained by summation made on the second pixel columns monotonously increase or monotonously decrease in one direction or not, and the pixel value of the predetermined pixel is replaced with a quotient obtained by dividing the summed pixel value of the individual pixels contained in the second pixel column including the predetermined pixel with the number of pixels contained in the second pixel column, when the column-wisely summed pixel values obtained by summation made on the second pixel columns monotonously increase or decrease in one direction, the count of stairs in one direction in the first pixel area is 2, an, the count of stairs in the other direction in the first pixel area is 1.

According to this embodiment, a geometry based on an arrangement of pixels which should not be reduced in height of stairs is successfully prevented from being unnecessarily smoothened. The image processing of this embodiment may be adoptable to all cases having a variety of pixel values of the rasterized image data, needs no binarization unlike the prior art, and can avoid the problem that the jaggy could not occasionally be removed due to binarization.

The image processing method further includes judging whether the column-wisely summed pixel values obtained by summation made on the first pixel columns monotonously increase or monotonously decrease in the other direction or not, and the pixel value of the predetermined pixel is replaced with a quotient obtained by dividing the summed pixel value of the individual pixels contained in the first pixel column including the predetermined pixel with the number of pixels contained in the first pixel column, when the column-wisely summed pixel values obtained by summation made on the first pixel columns monotonously increase or decrease in the other direction, the count of stairs in one direction in the first pixel area is 1, and the count of stairs in the other direction in the first pixel area is 2.

According to this embodiment, a geometry based on an arrangement of pixels, which should not be reduced in height of stairs, is successfully prevented from being unnecessarily smoothened. The image processing of this embodiment may be adoptable to all cases having a variety of pixel values of the rasterized image data, needs no binarization unlike the prior art, and can avoid the problem that the jaggy could not occasionally be removed due to binarization.

The image processing method further includes setting a second pixel area configured by a third predetermined number of pixels arranged in one direction out of the two directions, the third predetermined number of pixels being larger than the first predetermined number of pixels, and a fourth predetermined number of pixels arranged in the other direction, the fourth predetermined number of pixels being larger than the second predetermined number of pixels, so as to enclose the first pixel area, summing up the individual pixel values of the third predetermined number of pixels in a column-wise manner with respect to third pixel columns arranged in one direction in the second pixel area, summing up the individual pixel values of the fourth predetermined number of pixels in a column-wise manner with respect to fourth pixel columns arranged in the other direction in the second pixel area, identifying a count of stairs given by differences among the pixel values of the individual pixels in the second pixel area, respectively for one direction and for the other direction, based on the column-wisely summed pixel value obtained by summation made on the third pixel columns and the column-wisely summed pixel value obtained by summation made on the fourth pixel columns, and determining a pixel value of a predetermined pixel, based on a combination of a count of stairs in one direction in the first pixel area and a count of stairs in the other direction in the first pixel area and based on a combination of a count of stairs in one direction in the second pixel area and a count of stairs in the other direction in the second pixel area.

According to this embodiment, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

Preferably, the second pixel area is set, when any one condition selected from (i) the count of stairs in one direction in the first pixel area is 1, and, the count of stairs in the other direction in the first pixel area is 0; (ii) the count of stairs in one direction in the first pixel area is 2, and, the count of stairs in the other direction in the first pixel area is 1; (iii) the count of stairs in one direction in the first pixel area is 0, and, the count of stairs in the other direction in the first pixel area is 1; and (iv) the count of stairs in one direction in the first pixel area is 1, and, the count of stairs in the other direction in the first pixel area is 2, is satisfied.

According to this embodiment, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

Preferably, the image processing device sets a new second pixel area, assuming the previous second pixel area as a first pixel area, when any one condition selected from (i) the count of stairs in one direction in the second pixel area is 1, and, the count of stairs in the other direction in the second pixel area is 0; (ii) the count of stairs in one direction in the second pixel area is 2, and, the count of stairs in the other direction in the second pixel area is 1; (iii) the count of stairs in one direction in the second pixel area is 0, and, the count of stairs in the other direction in the second pixel area is 1; and (iv) the count of stairs in one direction in the second pixel area is 1, and, the count of stairs in the other direction in the second pixel area is 2, is satisfied.

According to this embodiment, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

According to another aspect of the preferred embodiment of the present invention, an image processing apparatus for processing image data having pixels consecutively arranged in two directions orthogonal to each other includes an image processing unit which sets a first pixel area configured by a first predetermined number of pixels arranged in one direction out of the two directions and a second predetermined number of pixels arranged in the other direction, sums up the individual pixel values of the first predetermined number of pixels in a column-wise manner with respect to first pixel columns arranged in one direction in the first pixel area, sums up the individual pixel values of the second predetermined number of pixels in a column-wise manner with respect to second pixel columns arranged in the other direction in the first pixel area, identifies a count of stairs given by differences among the pixel values of the individual pixels in the first pixel area, respectively for one direction and for the other direction, based on the column-wisely summed pixel value obtained by summation made on the first pixel columns and the column-wisely summed pixel value obtained by summation made on the second pixel columns, and determines a pixel value of a predetermined pixel contained in the first pixel area based on the count of stairs in one direction in the first pixel area and the count of stairs in the other direction in the first pixel area.

According to this embodiment, the pixels in need of replacement of the pixel values for the purpose of reducing the height of stairs of jaggy may clearly be discriminated from the pixels not in need of replacement, and thereby the smoothing may be completed in a more successful manner. In addition, according to this embodiment, the smoothing may be completed without template matching. In other words, there is no need of matching between templates and image data. Accordingly, expansion of the amount of computation necessary for the image processing in proportion to the number of templates to be matched, and increase in the process load of the image processing, both of which having been drawbacks of the prior art, may be resolved. In addition, since this embodiment needs no templates, it is no longer necessary to design the templates nor incorporate the templates into the circuits and program products. Accordingly, expansion of workload for designing the plurality of templates used for the template matching, and expansion of workload for incorporating the templates into circuits and program products, both of which having been drawbacks of the prior art, may be resolved. As may be understood from the above, the process load and workload necessary for the smoothing may considerably be decreased. Moreover, this embodiment includes no process for binarization which has been included in the prior art. This advantageously resolves the conventional problem that the jaggy could not be removed due to the binarization, and thereby makes the smoothing more successful.

Preferably, the image processing unit judges whether the column-wisely summed pixel values obtained by summation made on the second pixel columns monotonously increase or monotonously decrease in one direction or not, and replaces the pixel value of the predetermined pixel, with a quotient obtained by dividing the summed pixel value of the individual pixels contained in the second pixel column including the predetermined pixel with the number of pixels contained in the second pixel column, when the column-wisely summed pixel values obtained by summation made on the second pixel columns monotonously increase or decrease in one direction, the count of stairs in one direction in the first pixel area is 2 and the count of stairs in the other direction in the first pixel area is 1.

According to this embodiment, a geometry based on an arrangement of pixels, which should not be reduced in height of stairs, is successfully prevented from being unnecessarily smoothened. The image processing of this embodiment may be adoptable to all cases having a variety of pixel values of the rasterized image data, needs no binarization unlike the prior art, and can avoid the problem that the jaggy could not occasionally be removed due to binarization.

Preferably, wherein the image processing unit judges whether the column-wisely summed pixel values obtained by summation made on the first pixel columns monotonously increase or monotonously decrease in the other direction or not, and replaces the pixel value of the predetermined pixel with a quotient obtained by dividing the summed pixel value of the individual pixels contained in the first pixel column including the predetermined pixel with the number of pixels contained in the first pixel column, when the column-wisely summed pixel values obtained by summation made on the first pixel columns monotonously increase or decrease in the other direction, the count of stairs in one direction in the first pixel area is 1, and the count of stairs in the other direction in the first pixel area is 2.

According to this embodiment, a geometry based on an arrangement of pixels, which should not be reduced in height of stairs, is successfully prevented from being unnecessarily smoothened. The image processing of this embodiment may be adoptable to all cases having a variety of pixel values of the rasterized image data, needs no binarization unlike the prior art, and can avoid the problem that the jaggy could not occasionally be removed due to binarization.

Preferably, the image processing unit sets a second pixel area configured by a third predetermined number of pixels arranged in one direction out of the two directions, the third predetermined number of pixels being larger than the first predetermined number of pixels, and a fourth predetermined number of pixels arranged in the other direction, the fourth predetermined number of pixels being larger than the second predetermined number of pixels, so as to enclose the first pixel area, sums up the individual pixel values of the third predetermined number of pixels in a column-wise manner with respect to third pixel columns arranged in one direction in the second pixel area, sums up the individual pixel values of the fourth predetermined number of pixels in a column-wise manner with respect to fourth pixel columns arranged in the other direction in the second pixel area, identifies a count of stairs given by differences among the pixel values of the individual pixels in the second pixel area, respectively for one direction and for the other direction, based on the column-wisely summed pixel value obtained by summation made on the third pixel columns and the column-wisely summed pixel value obtained by summation made on the fourth pixel columns, and determines a pixel value of a predetermined pixel, based on a combination of a count of stairs in one direction in the first pixel area and a count of stairs in the other direction in the first pixel area, and based on a combination of a count of stairs in one direction in the second pixel area and a count of stairs in the other direction in the second pixel area.

According to this embodiment, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

Preferably, wherein the second pixel area is set, when any one condition selected from (i) the count of stairs in one direction in the first pixel area is 1, and, the count of stairs in the other direction in the first pixel area is 0; (ii) the count of stairs in one direction in the first pixel area is 2, and, the count of stairs in the other direction in the first pixel area is 1; (iii) the count of stairs in one direction in the first pixel area is 0, and, the count of stairs in the other direction in the first pixel area is 1; and (iv) the count of stairs in one direction in the first pixel area is 1, and, the count of stairs in the other direction in the first pixel area is 2, is satisfied.

According to this embodiment, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

Preferably, wherein the image processing unit sets a new second pixel area, assuming the previous second pixel area as a first pixel area, when any one condition selected from (i) the count of stairs in one direction in the second pixel area is 1, and, the count of stairs in the other direction in the second pixel area is 0; (ii) the count of stairs in one direction in the second pixel area is 2, and, the count of stairs in the other direction in the second pixel area is 1; (iii) the count of stairs in one direction in the second pixel area is 0, and, the count of stairs in the other direction in the second pixel area is 1; and (iv) the count of stairs in one direction in the second pixel area is 1, and, the count of stairs in the other direction in the second pixel area is 2, is satisfied.

According to this embodiment, the frequency of appearance of the edges causative of jaggy may be judged in a more appropriate manner. In other words, the pixels in need of replacement of the pixel values for the purpose of reducing the height of stairs of jaggy may clearly be discriminated from the pixels not in need of replacement, and thereby the smoothing may be completed in a more successful manner.

The entire disclosure of Japanese Patent Application No. 2010-236118 filed on Oct. 21, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image processing method for processing image data having pixels consecutively arranged in two directions orthogonal to each other, the method comprising:
setting a first pixel area configured by a first predetermined number of pixels arranged in one direction out of the two directions and a second predetermined number of pixels arranged in the other direction;
summing up the individual pixel values of the first predetermined number of pixels in a column-wise manner with respect to first pixel columns arranged in one direction in the first pixel area;
summing up the individual pixel values of the second predetermined number of pixels in a column-wise manner with respect to second pixel columns arranged in the other direction in the first pixel area;
identifying a count of stairs given by differences among the pixel values of the individual pixels in the first pixel area, respectively for one direction and for the other direction, based on the column-wisely summed pixel value obtained by summation made on the first pixel columns and the column-wisely summed pixel value obtained by summation made on the second pixel columns; and
determining a pixel value of a predetermined pixel contained in the first pixel area based on the count of stairs in one direction in the first pixel area and the count of stairs in the other direction in the first pixel area.

2. The image processing method of claim 1, further comprising:
judging whether the column-wisely summed pixel values obtained by summation made on the second pixel columns monotonously increase or monotonously decrease in one direction or not, wherein
the pixel value of the predetermined pixel is replaced with a quotient obtained by dividing the summed pixel value of the individual pixels contained in the second pixel column including the predetermined pixel with the number of pixels contained in the second pixel column, when the column-wisely summed pixel values obtained by summation made on the second pixel columns monotonously increase or decrease in one direction, the count of stairs in one direction in the first pixel area is 2, an, the count of stairs in the other direction in the first pixel area is 1.

3. The image processing method of claim 1, further comprising:
judging whether the column-wisely summed pixel values obtained by summation made on the first pixel columns monotonously increase or monotonously decrease in the other direction or not, and
the pixel value of the predetermined pixel is replaced with a quotient obtained by dividing the summed pixel value of the individual pixels contained in the first pixel column including the predetermined pixel with the number of pixels contained in the first pixel column, when the column-wisely summed pixel values obtained by summation made on the first pixel columns monotonously increase or decrease in the other direction, the count of stairs in one direction in the first pixel area is 1, and the count of stairs in the other direction in the first pixel area is 2.

4. The image processing method of claim 1, further comprising:
setting a second pixel area configured by a third predetermined number of pixels arranged in one direction out of the two directions, the third predetermined number of pixels being larger than the first predetermined number of pixels, and a fourth predetermined number of pixels arranged in the other direction, the fourth predetermined number of pixels being larger than the second predetermined number of pixels, so as to enclose the first pixel area;
summing up the individual pixel values of the third predetermined number of pixels in a column-wise manner with respect to third pixel columns arranged in one direction in the second pixel area;
summing up the individual pixel values of the fourth predetermined number of pixels in a column-wise manner with respect to fourth pixel columns arranged in the other direction in the second pixel area;
identifying a count of stairs given by differences among the pixel values of the individual pixels in the second pixel area, respectively for one direction and for the other direction, based on the column-wisely summed pixel value obtained by summation made on the third pixel columns and the column-wisely summed pixel value obtained by summation made on the fourth pixel columns; and
determining a pixel value of a predetermined pixel, based on a combination of a count of stairs in one direction in the first pixel area and a count of stairs in the other direction in the first pixel area and based on a combination of a count of stairs in one direction in the second pixel area and a count of stairs in the other direction in the second pixel area.

5. The image processing method of claim 4,
wherein the second pixel area is set, when any one condition selected from (i) the count of stairs in one direction in the first pixel area is 1, and, the count of stairs in the other direction in the first pixel area is 0; (ii) the count of stairs in one direction in the first pixel area is 2, and, the count of stairs in the other direction in the first pixel area is 1; (iii) the count of stairs in one direction in the first pixel area is 0, and, the count of stairs in the other direction in the first pixel area is 1; and (iv) the count of stairs in one direction in the first pixel area is 1, and, the count of stairs in the other direction in the first pixel area is 2, is satisfied.

6. The image processing method of claim 4,
wherein the image processing device sets a new second pixel area, assuming the previous second pixel area as a first pixel area, when any one condition selected from (i) the count of stairs in one direction in the second pixel area is 1, and, the count of stairs in the other direction in the second pixel area is 0; (ii) the count of stairs in one direction in the second pixel area is 2, and, the count of stairs in the other direction in the second pixel area is 1; (iii) the count of stairs in one direction in the second pixel area is 0, and, the count of stairs in the other direction in the second pixel area is 1; and (iv) the count of stairs in one direction in the second pixel area is 1, and, the count of stairs in the other direction in the second pixel area is 2, is satisfied.

7. An image processing apparatus for processing image data having pixels consecutively arranged in two directions orthogonal to each other, the apparatus comprising:
an image processing unit which
sets a first pixel area configured by a first predetermined number of pixels arranged in one direction out of the two directions and a second predetermined number of pixels arranged in the other direction,
sums up the individual pixel values of the first predetermined number of pixels in a column-wise manner with respect to first pixel columns arranged in one direction in the first pixel area,
sums up the individual pixel values of the second predetermined number of pixels in a column-wise manner with respect to second pixel columns arranged in the other direction in the first pixel area,
identifies a count of stairs given by differences among the pixel values of the individual pixels in the first pixel area, respectively for one direction and for the other direction, based on the column-wisely summed pixel value obtained by summation made on the first pixel columns and the column-wisely summed pixel value obtained by summation made on the second pixel columns, and
determines a pixel value of a predetermined pixel contained in the first pixel area based on the count of stairs in one direction in the first pixel area and the count of stairs in the other direction in the first pixel area.

8. The image processing apparatus of claim 7,
wherein the image processing unit judges whether the column-wisely summed pixel values obtained by summation made on the second pixel columns monotonously increase or monotonously decrease in one direction or not, and replaces the pixel value of the predetermined pixel, with a quotient obtained by dividing the summed pixel value of the individual pixels contained in the second pixel column including the predetermined pixel with the number of pixels contained in the second pixel column, when the column-wisely summed pixel values obtained by summation made on the second pixel columns monotonously increase or decrease in one direction, the count of stairs in one direction in the first pixel area is 2 and the count of stairs in the other direction in the first pixel area is 1.

9. The image processing apparatus of claim 7,
wherein the image processing unit judges whether the column-wisely summed pixel values obtained by summation made on the first pixel columns monotonously increase or monotonously decrease in the other direction or not, and replaces the pixel value of the predetermined pixel with a quotient obtained by dividing the summed pixel value of the individual pixels contained in the first pixel column including the predetermined pixel with the number of pixels contained in the first pixel column, when the column-wisely summed pixel values obtained by summation made on the first pixel columns monotonously increase or decrease in the other direction, the count of stairs in one direction in the first pixel area is 1, and the count of stairs in the other direction in the first pixel area is 2.

10. The image processing apparatus of claim 7,
wherein the image processing unit
sets a second pixel area configured by a third predetermined number of pixels arranged in one direction out of the two directions, the third predetermined number of pixels being larger than the first predetermined number of pixels, and a fourth predetermined number of pixels arranged in the other direction, the fourth predetermined number of pixels being larger than the second predetermined number of pixels, so as to enclose the first pixel area,
sums up the individual pixel values of the third predetermined number of pixels in a column-wise manner with respect to third pixel columns arranged in one direction in the second pixel area,
sums up the individual pixel values of the fourth predetermined number of pixels in a column-wise manner with respect to fourth pixel columns arranged in the other direction in the second pixel area,
identifies a count of stairs given by differences among the pixel values of the individual pixels in the second pixel area, respectively for one direction and for the other direction, based on the column-wisely summed pixel value obtained by summation made on the third pixel columns and the column-wisely summed pixel value obtained by summation made on the fourth pixel columns; and
determines a pixel value of a predetermined pixel, based on a combination of a count of stairs in one direction in the first pixel area and a count of stairs in the other direction in the first pixel area, and based on a combination of a count of stairs in one direction in the second pixel area and a count of stairs in the other direction in the second pixel area.

11. The image processing apparatus of claim 10,
wherein the second pixel area is set, when any one condition selected from (i) the count of stairs in one direction in the first pixel area is 1, and, the count of stairs in the other direction in the first pixel area is 0; (ii) the count of stairs in one direction in the first pixel area is 2, and, the count of stairs in the other direction in the first pixel area is 1; (iii) the count of stairs in one direction in the first pixel area is 0, and, the count of stairs in the other direction in the first pixel area is 1; and (iv) the count of stairs in one direction in the first pixel area is 1, and, the count of stairs in the other direction in the first pixel area is 2, is satisfied.

12. The image processing apparatus of claim 10,
wherein the image processing unit sets a new second pixel area, assuming the previous second pixel area as a first pixel area, when any one condition selected from (i) the count of stairs in one direction in the second pixel area is 1, and, the count of stairs in the other direction in the second pixel area is 0; (ii) the count of stairs in one direction in the second pixel area is 2, and, the count of stairs in the other direction in the second pixel area is 1; (iii) the count of stairs in one direction in the second pixel area is 0, and, the count of stairs in the other direction in the second pixel area is 1; and (iv) the count of stairs in one direction in the second pixel area is 1, and, the count of stairs in the other direction in the second pixel area is 2, is satisfied.
